(19) United States
(12) Patent Application Publication
(10) Pub. No.: US 2013/0069769 A1
(43) Pub. Date: Mar. 21, 2013

(54) REMOTE CONTROL USER INTERFACE FOR HANDHELD DEVICE

(71) Applicants: Gareth Pennington, Castro Valley, CA (US); Adrien Lazzaro, Fremont, CA (US); Sneha Patel, Mississauga (CA); Andrew Brenner, Sunnyvale, CA (US); Christopher Benoit, Burlington (CA); Tate Postinkoff, San Jose, CA (US)

(72) Inventors: Gareth Pennington, Castro Valley, CA (US); Adrien Lazzaro, Fremont, CA (US); Sneha Patel, Mississauga (CA); Andrew Brenner, Sunnyvale, CA (US); Christopher Benoit, Burlington (CA); Tate Postinkoff, San Jose, CA (US)

(73) Assignee: LOGITECH Europe S.A., Morges (CH)

(21) Appl. No.: 13/552,566

(22) Filed: Jul. 18, 2012

Related U.S. Application Data
(60) Provisional application No. 61/509,082, filed on Jul. 18, 2011.

(51) Int. Cl. G05B 11/01

(52) U.S. Cl. 340/12.28

(57) ABSTRACT

Systems and methods for enabling the use of a device to control multiple devices that participate in the presentation of content are disclosed. In particular, a first device may receive information corresponding to the state of appliances to be controlled. A second device having a graphical user interface may be enabled by the first device to update its graphical user interface in accordance with the appliance states for which the first device receives information. In some embodiments, the second device is a handheld device that controls the appliances.

### CROSS REFERENCE TO RELATED APPLICATIONS

This application claims the benefit of U.S. Provisional Application No. 61/509,082, entitled “Remote Control User Interface for Handheld Device,” filed Jul. 18, 2011 (Attorney Docket No. 89572-814438 (091010US)), which is incorporated herein by reference. This application also incorporates, for all purposes, the entire disclosure of U.S. application Ser. No. 09/804,718 (now U.S. Pat. No. 6,784,805), entitled “State-Based Remote Control System” filed on Mar. 12, 2001 and pending U.S. application Ser. No. 12/993,248 entitled “Apparatus and Method of Operation for a Remote Control System” filed on Nov. 17, 2010.

### REFERENCE TO APPENDICES

An Appendix is being filed as part of this application. The present application incorporates by reference for all purposes the entire contents of the Appendix.

### BACKGROUND OF THE INVENTION

Remote control devices have been in use for many years. Remote control devices are utilized to operate various external electronic devices including but not limited to televisions, stereos, receivers, VCRs, DVD players, CD players, amplifiers, equalizers, tape players, cable units, lighting, window shades and other electronic devices. A conventional remote control is typically comprised of a housing structure, a keypad within the housing structure for entering commands by the user, electronic circuitry within the housing structure connected to the keypad, and a transmitter electrically connected to the electronic circuitry for transmitting a control signal to an electronic device to be operated.

The user depresses one or more buttons upon the keypad when an operation of a specific electronic device is desired. For example, if the user desires to turn the power off to a VCR, the user will depress the power button upon the remote control which transmits a “power off” control signal that is detected by the VCR resulting in the VCR turning off.

Because of the multiple electronic devices currently available within many homes and businesses today, a relatively new type of remote control is utilized to allow for the control of a plurality of electronic devices commonly referred to as a “universal remote control.” Most universal remote controls have “selector buttons” that are associated with the specific electronic device to be controlled by the remote control (e.g. television, VCR; DVD player, etc.). Universal remote control devices allow for the control of a plurality of external electronic devices with a single remote control, thereby eliminating the need to have a plurality of remote controls physically present within a room.

While conventional remote controls work well for many purposes, typical utilization of remote controls is not ideal. For example, many universal remote controls have a large number of buttons, many of which may never be used, since the manufacturers attempt to have physical buttons for many, if not all, possible command of each possible electronic device. Additionally, even when large numbers of buttons are included in the remote, the programming and compatibility of the remote with new devices are often limited. The result is often a device that is cumbersome and not intuitive. Also, electronic components within these devices can be relatively complex and expensive to manufacture, resulting in an increased cost to the consumer.

While these devices may be suitable for the particular purpose to which they are addressed, from the perspectives of cost, ease of use, and expandability, they are not optimal. Accordingly, there exist ongoing needs to provide remote control systems that can be applied to multiple devices in a more intuitive and expandable manner.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Techniques, including systems and methods, of the present disclosure enable the use of a device to control multiple devices that participate in the presentation of content. In one embodiment, a remote control system allows a user to control multiple devices using local equipment. In some embodiments, the remote control system enhances usability by obtaining information from external sources, such as remote servers accessible over a public communications network.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

In accordance with various embodiments of the present disclosure, a remote control system is disclosed. The remote control system may include one or more processors and memory including instructions executable by the one or more processors to cause the remote control system synchronize graphical user interfaces of one or more handheld devices. In an embodiment, the remote control system receives, from a first handheld device, one or more signals corresponding to a state of a set of one or more controllable appliances and causes transmission of, to a second handheld device having a remote control graphical user interface, one or more signals that collectively enable the second handheld device to update the remote control graphical user interface to correspond to the state. The first handheld device may be, for example, a remote control device, such as a remote control device dedicated to a particular controllable appliance and/or a universal remote control device. The first handheld device may have a remote control graphical user interface and the one or more signals corresponding to the state of the set of one or more controllable appliances may be generated responsive to user input to the graphical user interface. The memory may include instructions that, when executed by the one or more processors, cause the remote control system to further: receive, from the second handheld device, one or more other signals corresponding another state of the set of one or more controllable appliances; and cause transmission, to the first handheld device, of one or more other signals that collectively enable the first handheld device to update the remote control graphical user interface of the first handheld device to correspond to the other state.

In an embodiment, at least one of the first handheld device or second handheld device is connected to the remote control system by a local communication network. Transmission of the one or more signals that collectively enable the second handheld device to update the remote control graphical user interface may then occur over the local communication network. Causing transmission of the one or more signals that collectively enable the second handheld device to update the remote control graphical user interface may be performed in various ways, such as by causing another device to transmit the one or more signals that collectively enable the second handheld device to update the remote control graphical user interface. In an embodiment, the memory includes instructions that, when executed by the one or more processors, cause the remote control system to further upon receipt of the one or more signals corresponding to the state of the set of one or more controllable appliances, determine, based at least in part on the state, whether to cause transmission of the one or more signals that collectively enable the second handheld device to update the remote control graphical user interface. As a result of determining to cause transmission of the one or more signals, the remote control system may cause transmission of the one or more signals that collectively enable the second handheld device to update the remote control graphical user interface.

In various embodiments, the first handheld device and the second handheld device are different types of devices. For example, the first handheld device may be a remote controller while the second handheld device may be a mobile communication device (e.g., smartphone or tablet computer). In some instances, the one or more signals corresponding to the state of the set of one or more controllable appliances are in accordance with a first communication protocol; and the one or more signals that collectively enable the second handheld device to update the remote control graphical user interface are in accordance with a second communication protocol that is different from the first communication protocol. In this manner, the remote control system acts as a bridge between different protocols. In some embodiments, prior to receipt of the one or more signals corresponding to the state of the set of one or more controllable appliances, the set of one or more controllable appliances is in a first state corresponding to consumption of media in a first mode and the state corresponding to the one or more signals corresponds to consumption of media in a second mode different from the first mode. Further, the memory may include instructions that, when executed by the one or more processors, cause the remote control system to further transmit one or more command signals to at least a subset of the set of one or more controllable appliances to put the set of one or more controllable appliances in the state.

In accordance with various embodiments, a computer-implemented method of updating graphical user interface state among a set of handheld devices is described. The method may be performed, for example, by a remote control system such as described above or another device. In an embodiment, the method includes: receiving, from a first handheld device of the set of handheld devices, one or more signals for causing a state of a set of one or more controllable appliances to change to a new state; and taking one or more actions that cause one or more other handheld devices to synchronize corresponding remote control graphical user interfaces according to the new state. The first handheld device may be, for instance, a remote controller. In some embodiments, the first handheld device has a first remote control graphical user interface; and the method further comprises taking one or more other actions that cause the first remote control graphical user interface to update as a result of a second handheld device of the set of one or more handheld devices causing another change in state of the set of one or more controllable appliances. Also, at least one second handheld device of the one or more other handheld devices may be connected to the remote control system by a local communication network; and the one or more actions include transmission of a signal over the local communication network to the second handheld device. In an embodiment, taking one or more actions that cause the one or more other handheld devices to synchronize corresponding remote control graphical user interfaces is performed as a result of a determination to take the one or more actions.

Other variations considered as being within the scope of the present disclosure include the one or more signals being according to a first communication protocol and the one or more actions including causing transmission of a signal of a second communication protocol different from the first communication protocol. Changing to a new state may include causing at least one controllable appliances of the set of controllable appliances to change a mode of consuming media content. The method may also further comprise transmitting one or more signals to at least a subset of the set of one or more controllable appliances to cause the set of one or more controllable appliances to be in the new state. In other embodiments, this may be performed by another device different from a device (or collection of devices) that performs the method.

Various embodiments of the present disclosure are also directed to computer-readable storage media, which may be non-transitory. In an embodiment, a non-transitory computer-readable storage medium has stored thereon instructions that, when executed by one or more processors of a handheld device, cause the handheld device to update a remote control graphical user interface. The handheld device may, for instance, receive, from a first device, at least one signal corresponding to a change of state of a set of one or more controllable appliances to a new state, the change of state initiated by another handheld device; and update the remote control graphical user interface of the handheld device to enable the graphical user interface to be usable to control at least a subset of the set of one or more controllable appliances according to the new state. The instructions may further include instructions that when executed by the one or more processors, further cause the handheld device to: accept, by the graphical user interface, user input for controlling at least one of the one or more controllable appliances; and take one or more actions that cause the at least one of the one or more controllable appliances to function in accordance with the accepted user input.

As above, numerous variations are considered as being within the scope of the present disclosure. For example, the one or more actions may include transmitting, to the first device, a signal corresponding to the accepted user input. As another example, the instructions may further include instructions that, when executed b the one or more processors, further cause the handheld device to poll the first device to cause the first device to transmit the at least one signal. Receiving the at least one signal may be performed without transmission of the at least one signal from the first device having been initiated by the handheld device. Prior to receipt of the signal, the set of one or more controllable appliances may be in a previous state and, when the set of one or more controllable appliances is in the previous state, the graphical user interface may have a set of one or more selectable remote control functions. Updating the remote control graphical user interface may then include changing the set of one or more selectable remote control functions. Receiving the at least one signal is performed over a local communication network, in various embodiments. Further, receiving the at least one signal may be performed according to a first communication protocol and the state of the set of the one or more controllable appliances may be changeable using at least one other communication protocol different from the first communication protocol.

For a fuller understanding of the nature and advantages of the present invention, reference should be made to the ensuing detailed description and accompanying drawings.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced. In the drawings:

FIG. 1 is an illustrative example of an environment that may be used to practice various aspects of the invention in accordance with at least one embodiment;

FIG. 2 is an illustrative example of another environment that may be used to practice various aspects of the invention in accordance with at least one embodiment;

FIG. 3 is an illustrative example of a process indicating to a handheld device to update a user interface in accordance with at least one embodiment;

FIG. 4 is an illustrative example of a process for updating a user interface on a handheld device in accordance with at least one embodiment;

FIG. 5 is an illustrative example of a state-dependent process for indicating to a handheld device to update a UI in accordance with at least one embodiment; and

FIGS. 6-11 are illustrative examples of Iii screen displays on a handheld device in accordance with at least one embodiment.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. It also is to be noted that as used herein and in the appended claims, the singular forms “a,” “an,” and “the” include the plural reference unless the context clearly dictates otherwise. Thus, for example, a reference to “a flap” is a reference to one or more flaps and equivalents thereof known to those skilled in the art.

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

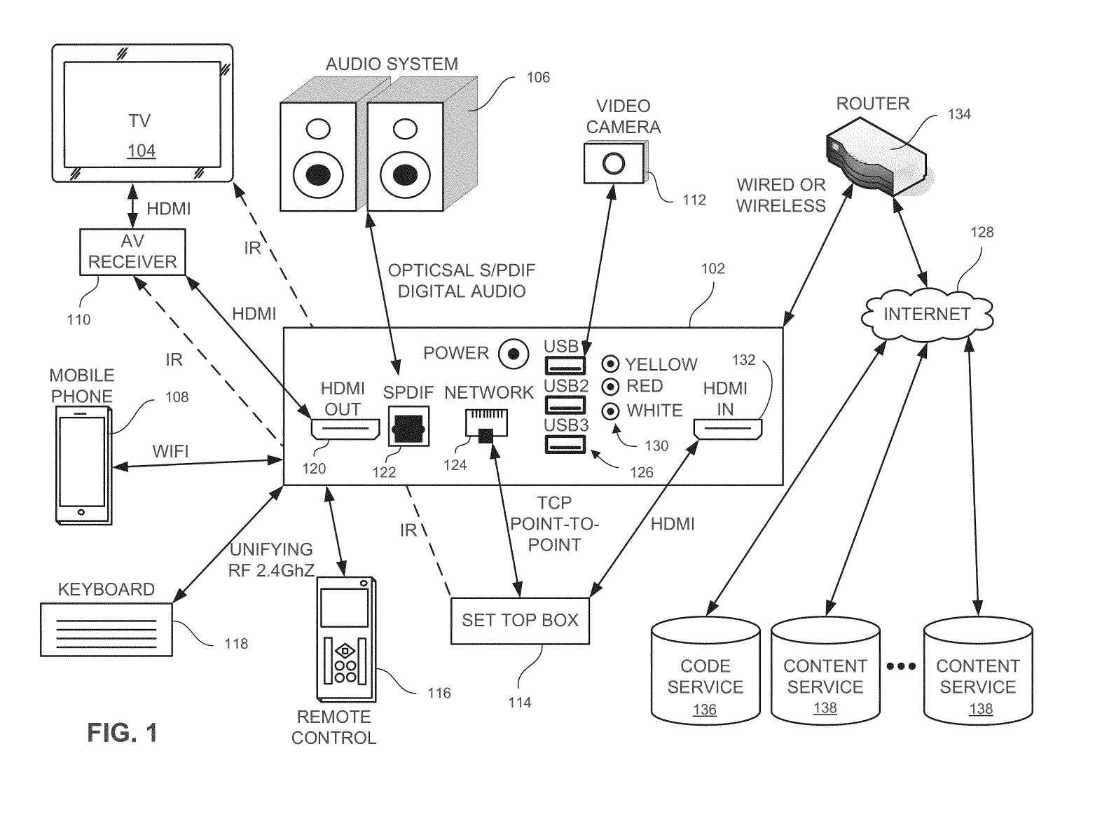

FIG. 1 shows an environment 100 in which various embodiments may be practiced. In accordance with an embodiment, the environment 100 utilizes a content appliance 102 in order to provide content to a user. As illustrated in FIG. 1, the content may be provided to the user in various ways. For example, the environment 100 in FIG. 1 includes a television 104, an audio system 106 and a mobile device 108 (such as a mobile phone) that may be used to provide content to a user. Content may include video content, audio content, text content, and generally any type of content that may be provided audibly, visually, or otherwise to a user. Other devices may also be used in the environment 100. For example, as illustrated in FIG. 1, the environment 100 includes an audio visual (AV) receiver 110 which operates in connection with a television 104. Also, the environment 100 as illustrated in FIG. 1 includes a video camera 112, a set top box 114, and a remote control 116, and a keyboard 118.

When a user utilizes an environment, such as the environment 100, one or more devices may utilize the content appliance 102 in some manner. To accomplish this, the various devices shown in FIG. 1 are configured to communicate with one another according to various protocols. As a result, in an embodiment, the content appliance 102 configured to communicate with various devices utilizing the different methods, such as according to the methods and protocols illustrated in FIG. 1. For example, in an embodiment, the content appliance 102 is configured to generate and transmit infrared (IR) signals to various devices that are configured to receive IR signals and perform one or more functions accordingly. Different devices may utilize different codes and the content appliance may be configured to generate proper codes with each appliance. For example, a television from one manufacturer may utilize different codes than a television from another manufacturer. The content appliance 102 may be configured accordingly to generate and transmit appropriate codes. The content appliance may include a data store that has the codes for various devices and/or codes may be obtained from remote sources, such as from remote databases as discussed below. In a set up process, a user may configure the content appliance 102 to submit the correct codes to the appropriate device(s).

As another example of how the content appliance 102 is able to communicate utilizing various protocols, the content appliance 102 includes various ports which may be used to connect with various devices, For example, in an embodiment, the content appliance 102 includes an HDMI OUT port 120 which may be used to provide content through an HDMI cable to another device. For example, as illustrated in FIG. 1, the HDMI OUT port 120 communicates content to the AV receiver 110. The HDMI OUT port may be used to provide content to other devices, such as directly to the television 104. In an embodiment, the content appliance 102 includes an S/PDIF port 122 to communicate with the audio system 106.

An ethernet port 124 may be provided with the content appliance 102 to enable the content appliance 102 to communicate utilizing an appropriate networking protocol, such as illustrated in FIG. 1. For example, the content appliance 102 may communicate signals utilizing the ethernet port 124 to communicate to a set top box. The set top box may operate according to an application of a content provider such as a satellite or cable television provider. The ethernet port 124 of the content appliance 102 may be used to instruct the set top box 114 to obtain content on demand. The content appliance may also be configured to communicate with other devices, such as the mobile device 108 (or generally any handheld device), remote control 116, or other device, whether handheld or not, using various other methods, such as any of the protocols listed shown in FIG. 1 and other protocols including, but not limited to, Wi-Fi, Home Network Administration Protocol (HNAP), BlueTooth, and others.

In an embodiment, the content appliance 102 includes one or more universal serial bus (USB) ports 126. The USB ports 126 may be utilized to communicate with various accessories that are configured to communicate utilizing a USB cable. For example, as shown in FIG. 1, the content appliance 102 communicates with a video camera 112. The video camera 112 may be used, for instance, to enable use of the content appliance to make video calls over a public communications network, such as the Internet 128, Generally, the content appliance 102 may be configured to communicate with any device connectable using USB techniques.

Other ports on the content appliance 102 may include RCA ports 130 in order to provide content to devices that are configured to communicate using such ports and an HDMI end port 132 which may be used to accept content from another device, such as from the set top box 114. Generally, the content appliance 102 may have additional ports to those discussed above and, in some embodiments, may include fewer ports than illustrated.

Various devices in communication with the content appliance 102 may be used to control the content appliance and other devices in the environment 100. For example, the remote e control 116 may communicate with the content appliance 102 utilizing radio frequency (RF) communication. As described in more detail below, the remote control 116 may include a touch screen that may be used in accordance with the various embodiments described herein.

A keyboard 118 may also communicate with the content appliance 102 utilizing RF or another method (and possibly one or more other devices, either directly, or through the content appliance 102). The keyboard may be used for various actions, such as navigation on a interface displayed on the television 104, user input by a user typing utilizing the keyboard 118, and general remote control functions. For example, an interface displayed on the television 104 may include options for text entry. The user may type text utilizing keyboard 118. Keystrokes that the user makes on the keyboard 118 may be communicated to the content appliance 102, which in turn generates an appropriate signal to send over an HDMI cable connecting the OUT port 120 to the AV receiver 110. The AV receiver 110 may communicate with the television 104 over HDMI or another suitable connection to enable the television to display text or other content that corresponds to the user input. The keyboard 118 may also include other features as well. For example, the keyboard 118 may include a touchpad, such as described below or generally a touchpad that may allow for user navigation of an interface displayed on a display device. The touchpad may have proximity sensing capabilities to enable use of the keyboard in various embodiments of the present disclosure.

In an embodiment, the mobile device 108 is also able to control the content appliance 102 (and possibly other devices, either directly, or through the content appliance 102). The mobile device may include a remote control application that provides an interface for controlling the content appliance 102. In this particular example from FIG. 1, the mobile device 108 includes a touch screen that may be used in a manner described below. As the user interacts with the mobile device 108, the mobile device may communicate with the content appliance 102 over wi-fi. utilizing signals that correspond to the user's interaction with the mobile device 108. The content appliance 102 may be, for instance, configured to receive signals from the mobile device over wi-fi (directly, as illustrated, or indirectly, such as through a wireless router or other device). The content appliance may be configured to generate signals of another type (such as IR, HDMI, RF, and the like) that correspond to codes received over wi-fi from the mobile device 108 and then generate and transmit signals accordingly. Alternatively, in an embodiment, codes themselves may not be transmitted by the mobile device, but the mobile device may transmit information encoding generic commands (such as “Turn on TV” or “Watch TV”) which may then be interpreted by the content appliance 102 to determine which IR or other commands are needed to be sent to achieve a corresponding result. Appropriate signals may then be broadcast or otherwise transmitted to one or more appropriate devices.

An application executing on the mobile device 108 may provide a graphical user interface that allows users to use the mobile device 108 as a remote control and generate such codes accordingly. The mobile device 108 (and other devices), as illustrated, may be configured to receive information from the content appliance 102 and reconfigure itself according to the information received. The mobile device 108 may, for example, update a display and/or update any applications executing on the mobile device 108 according to information received by the content appliance 102. It should be noted that, while the present disclosure discusses a mobile device illustrated as a mobile phone, the mobile device may be a different device with at least some similar capabilities. For example, the mobile device may be a portable music player or tablet computing device with a touch screen. Example mobile devices include, but are not limited to, various generations of iPhones, iPods, and IPads available from Apple Inc., mobile phones, tablets, and other devices having Android, Windows Phone, Blackberry, or other operating systems, and the like. The mobile device may be a device with a display and hard buttons (such as physically displaceable buttons) whose functionality may change depending on context and whose currently functionality is displayed on the display. Of course, such devices (and other devices) may be included additionally in a mobile device in the environment illustrated in FIG. 1.

In an embodiment, the content appliance 102 is also configured to utilize various services provided over a public communications network, such as the Internet 128. As an example, the content appliance 102 may communicate with a router 134 of a home network. The content appliance 102 and the router 134 may communicate utilizing a wired or wireless connection. The router 134 may be directly or indirectly connected to the Internet 128 in order to access various third-party services. For example, in an embodiment, a code service 136 is provided. The code service in an embodiment provides codes to the content appliance 102 to control various devices to enable the content appliance to translate codes received from another device (such as the remote control 116, the keyboard 118, and/or the mobile device 108). The various devices to control may be identified to the content appliance 102 by user input or through automated means. The content appliance 102 may submit a request through the router 134 to the code service 136 for appropriate codes. The codes may be, for example, IR codes that are used to control the various devices that utilize IR for communication. Thus, for example, if a user presses a button on the remote control 116, keyboard 118, or an interface element of the mobile device 108, a signal corresponding to the selection by the user may be communicated to the content appliance 102. The content appliance 102 may then generate a code based at least in part on information received from the code service 136. As an illustrative example, if the user presses a play button of the remote control 116, a signal corresponding to selection of the play button may be sent to the content appliance 102 which may generate a play IR code, which is then transmitted to the television 104 or to another suitable appliance, such as generally any appliance that is able to play content. As discussed, the signal (or signals) received by the content appliance 102 may be a signal that encodes a specific play command for one or more specific devices, or may be a signal that encodes a generic play command.

Other services that may be accessed by the content appliance 102 over the Internet 128 include various content services 138. The content services may be, for example, any information resource, such as websites, video-streaming services, audio-streaming services and generally any services that provide content over the Internet 128. A content service may also provide programming information for a remote control application interface of a handheld device or other device). An example content service is available from Rovi Corporation, which provides current programming information that may be used to implement various embodiments of the present disclosure.

It should be noted that the environment illustrated in FIG. 1 is provided for the purpose of illustration and that numerous environments may be used to practice embodiments of the present disclosure. Various embodiments, for example, are applicable in any environment where proximity sensing is used as a method of enabling user input, including any environment in which a touch screen with proximity sensing capabilities is used to interact with a graphical user interface (GUI) on a separate display. As just one example, FIG. 1 shows an environment in which user input is provided to a display (television, in the illustrated example) through a content appliance. However, techniques of the present disclosure are also applicable for providing user input directly to a device with a display. For instance, the various techniques described herein may be used in connection with a television remote control device, where the television remote control device sends signals according to user interaction with a touch screen directly to a television.

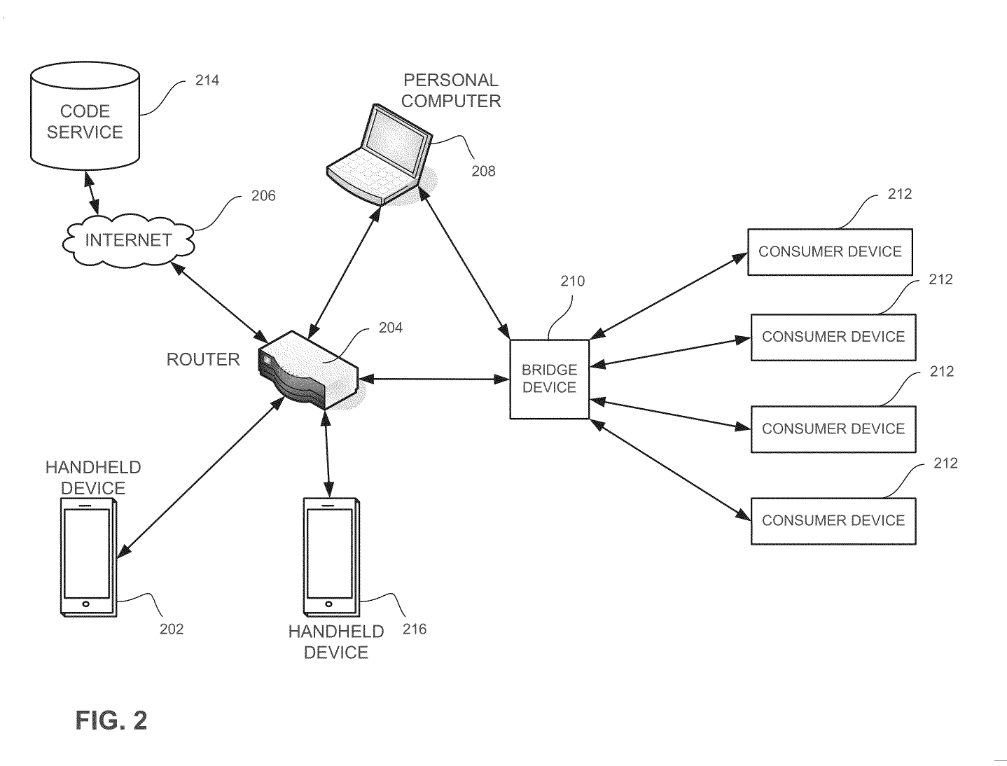

FIG. 2 shows an alternate environment that may be used to practice aspects of the present disclosure, either separately from or in connection with the environment illustrated in FIG. 1. As illustrated, the environment in FIG. 2 includes many devices that are the same or similar to devices described above in connection with FIG. 1. In FIG. 2, for example, the environment includes a handheld device 202 that communicates with a router 204 of a local network, such as a home network of a user of the handheld device 202. The handheld device may be a mobile phone, personal music player, tablet computing device, or other handheld device. The handheld device 202 may also include various features, such as a touch screen interface that allows users to interact with graphical user interfaces displayed on the touch screen. The handheld device 202 may, in addition or alternatively, include hard buttons, such as described above.

The router 204 may allow various devices to communicate among themselves as well as with external devices, that is devices outside of the home network, but accessible over another network, such as the Internet 206. The handheld device 202, for example, may communicate with the router 204 to communicate with external devices (such as web or other servers) over the Internet 206. A personal computer 208, for example, may similarly communicate with external devices through the router 204.

In an embodiment, the environment shown in FIG. 2 includes a bridge device 210. The bridge device may be any device configured to receive signals (directly or indirectly) from one device and transmit corresponding signals to one or more other devices. The bridge device 210 may be, as an example, the content appliance 102 described in connection with FIG. 1 or another device with some or all of the capabilities of the content appliance 102. For example, the handheld device may include a remote control application that provides a user interface for controlling one or more other devices, as described in more detail throughout the present disclosure. When the user interacts with the user interface, signals may be sent from the handheld device 202 to the bridge device 210. As illustrated in FIG. 2, the handheld device 202 communicates to the bridge device 210 through the router 204. The handheld device may, for example, send network traffic to an Internet Protocol (IP) address of the bridge device 210 that was assigned to the bridge device 210 by a dynamic host configuration protocol (DHCP) server of the router 204. The traffic may be sent in a variety of ways, such as over Wi-Fi to the router. HNAP, BlueTooth, Wi-Fi, and/or other protocols may be used for some or all of the route from the handheld device to the bridge device 210. However, the handheld device 202 and bridge device 204 may also be configured such that the handheld device 202 has the ability to send communications to the bridge device 210 directly or in other ways.

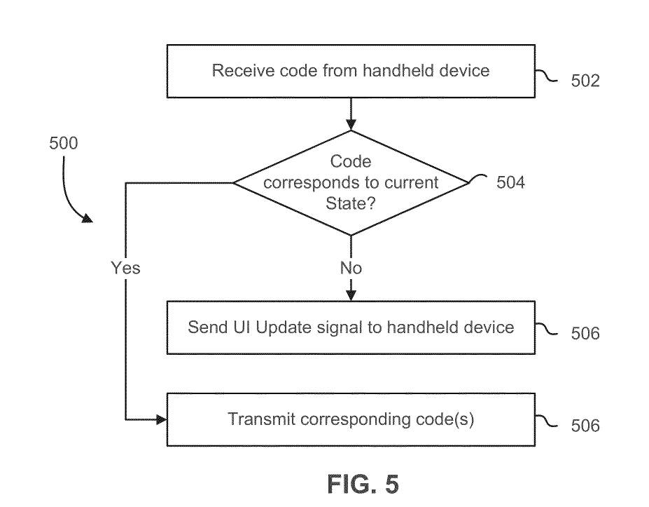

Communications from the handheld device 202 to the bridge device 210 may correspond to commands selected by a user on an interface provided on the handheld device 202. As an illustrative example, if a user selects a “volume up” command from the interface, a signal corresponding to the command may be sent to the bridge device 210. The “volume up” command may be a general “volume up” command or may be specific to a particular device (e.g. television or audio-video receiver) and the communication from the handheld device. In any event, upon receipt of a communication from the handheld device 202, the bridge device 210 may then send a corresponding command to one or more consumer devices 212. For instance, continuing the “volume up” example, the bridge device 210 may transmit an infrared signal to a television that, when detected by the television, causes the television to increase its volume. It should also be noted that commands may also be more complex and the bridge device 210 may transmit multiple signals, perhaps to multiple devices. For instance, as illustrated in various examples disclosed herein, a user may select an activity on an interface of the handheld device. For example, a user may select a “watch a DVD” activity. A corresponding signal may be sent from the handheld device 202 to the bridge device 210 accordingly. The bridge device 210 may then send multiple signals that put a set of devices in a proper state for watching a DVD. The bridge device 210 may, for example, send a signal that causes a DVD player to be in a powered on state, a signal that causes a television to be in a powered on state, a signal that changes the state of the television to accept input from the DVD player, and possibly other signals required for a user's particular configuration of one or more devices that participate in providing MD content. Alternatively, the handheld device 202 may send a signal for each action that needs to happen to watch a DVD and the bridge device 210 may send corresponding signals as they are received. It is contemplated that, in some embodiments, the selection of some activities may require the bridge device to communicate, directly or using one or more of the connected devices (e.g., by way of a network router), to complete or effect the selected activity, for example when selecting activities that are driven by content. For example, a user may select a “watch ‘XYZ’ movie” activity. Upon transmission of a corresponding signal from the handheld device to the bridge device, the bridge device may, among other actions, query one or more network locations to begin downloading or streaming the selected movie, for example, by requesting the streaming of the movie over the Internet. If an activity is ambiguous, e.g., if the same movie is available from a plurality of sources, the user may be given a choice so as to effect the appropriate sequence of actions taken by the bridge device. In some embodiments, the handheld device itself serves as an endpoint of the execution of the selected activity, e.g., when selecting “watch ‘XYZ’ movie on this smartphone” on a smartphone. Additionally, in accordance with the selection of an activity, certain user interface components may be updated, as discussed below in connection with FIG. 5, on the connected handheld device(s).

To enable the bridge device to send signals corresponding to signals from the handheld device, various techniques may be used. For example, in an embodiment, the bridge device 210 maintains a table that associates codes received by the handheld device 202 with corresponding codes for transmission to other devices 212. Many devices operate according to different codes. For example, the code that causes a volume increase in one television may be different than a code that causes a volume increase in another television. Accordingly, in an embodiment, the bridge device 210 is configured to, upon receipt of a signal from the handheld device 202, transmit a correct signal for a user's particular setup of devices.

In an embodiment, a code service 214, such as the code service discussed above in connection with FIG. 1, maintains a database of codes for multiple consumer devices. A user may use information from the code service to configure the bridge device 210 for his or her particular configuration of devices. For instance, as illustrated in FIG. 2, the user may connect (temporarily or persistently) his or her bridge device 210 to the personal computer 208 (such as through a universal serial bus (USB) connection) that executes an application for configuring the bridge device 210. The application may work in connection with an interface that allows the user to input information that identities his or her particular devices. For example, the user may input model numbers for the devices 212. The user may also input information that specifies how the devices are connected with one another. For example, the user may input whether volume is controlled through a television or through an audio-video receiver or other device of the user. Upon receipt of information identifying the devices, the code service 214 may provide information that enables the personal computer 208 to configure the bridge device 210 to transmit correct signals. Configuring the bridge device may include configuring a table that associates possible codes that may be received from a handheld device with codes that may be transmitted. In this manner, the handheld device 202 may transmit the same signal (or signals) for each command regardless of the particular setup of user devices and the bridge device 210 will translate the received signal to an appropriate signal accordingly.

By configuring the bridge device 210 to receive communications from the handheld device 202 (and/or other devices) directly through a local network instead of over a public communications network (such as the Internet) is advantageous as communications are able to reach the bridge device 210 with minimal latency, thereby providing an optimal user experience. For example, the handheld device 202 may be able to communicate with the bridge device using Wi-Fi or other technologies (such as those described above) without having to establish a connection with a remote server, waiting for a response from a remote server, and/or otherwise being subject to latencies and unpredictability of a public communications network. At the same time, advantages of a central code database accessible through a remote code service in various embodiments allow for maximum functionality including an efficient system for obtaining codes for devices out of numerous possible devices and efficient updates when, for example, new devices are purchased and/or when new devices are used that did not exist at the time of a previous configuration of the bridge device 210.

Some embodiments may, however, may dynamically access remote information sources, such as a code service. For instance, in an alternate embodiment, the code service 214 may be configured such that the bridge device is able to obtain necessary information on demand. For example, upon receipt of a signal specifying a command from the handheld device 202, the bridge device may submit a request (such as a web service request) to the code service 214 which may respond with information encoding a code for the bridge device to transmit to one or more of the consumer devices 212. The request to the code service 214 may encode information corresponding to the code received by the bridge device 210 and may include an identifier to enable the code service 214 to lookup the identifier to provide a code appropriate for a particular device setup of the user.

Other configurations are also considered as being within the scope of the present disclosure. For example, the bridge device 210 may maintain a large table that associates codes receivable from the handheld device 210 with appropriate codes for multiple devices, including devices not part of a user's configuration. The signals transmitted by the handheld device may correspond to specific devices in the user's configuration. For example, the handheld device may send a signal for a “channel up” command for a television that would be different for other televisions, such as televisions of another manufacturer.

In addition, as discussed, computing logic for controlling devices may be distributed among various devices participating in an environment, such as the environment illustrated in FIGS. 1 and 2 and variations thereof. As described, in one embodiment, handheld devices may send generic codes corresponding to commands and/or activities to a bridge device which, based at least in part on a particular configuration of one or more consumer devices of a user, determines appropriate codes for transmitting to the determined codes to the devices. In this embodiment, the handheld device is agnostic to the actual codes needed to cause the consumer devices to be in a proper state and the programming logic resides in the bridge device. In another embodiment, the handheld device may send to the bridge device codes that are specific to a user's configuration of consumer devices. For instance, if the user selects a “power on” option for a television (or an activity that requires a television) on a handheld device, the handheld device may send to the bridge device a code that is specific to the user's specific television. In other words, the code that is sent from the handheld device to the bridge device may be different than if the user had a different television. In this embodiment, computing logic for determining the proper codes resides in the handheld device. The bridge device, in this embodiment, may (but does not necessarily) have minimal logic. For instance, the bridge device may have logic for converting codes from the handheld device encoded by one method (e.g. Wi-Fi) to another method (e.g. infrared (IR)). In yet another embodiment, a handheld device may have the capability of communicating commands directly to one or more consumer devices. A handheld device, for instance, may be configured to transmit IR signals directly to one or more consumer devices. The computing logic for determining the correct codes to transmit to the consumer device(s) may be, therefore, in the handheld device. A bridge device may be used to transmit codes to consumer devices for which the handheld device is not configured to transmit codes. For instance, the handheld device may send IR codes directly to devices configured to receive IR codes, but the handheld device may send codes to the bridge device to cause the bridge device to transmit codes by another method, such as a High Definition Multimedia Interface (HDMI) method. Generally, the computing logic for various embodiments of the disclosure may be distributed in various ways and are not limited to those disclosed explicitly herein.

Various embodiments of the present disclosure may allow for multiple handheld devices to be used to control consumer devices. FIG. 2, for instance, shows an additional handheld device 216 that may be used in a manner described above. The additional handheld device 216 may be the same type of handheld device as the handheld device 202 or another type of handheld device. For example, the handheld devices may be different devices, with different operating systems, made by different manufacturers, and the like. Each handheld device may, however, execute a remote control application that provides a remote control interface, an illustrative example of which is provided herein with the additional Figures and Appendix. It should be noted that, while the environment shown in FIG. 2 illustrates two handheld devices, more or less than two handheld devices may be used.

As shown in the accompanying illustrative example of a remote control user interface, the interface of the application may change state as the user navigates throughout the various screens of the application (many illustrative examples of which are included herein). For example, if a user selects an option of the interface for watching television, the interface may change to a state where options more relevant to watching television are shown. When multiple handheld devices are used, complexities are introduced. For example, if one multiple handheld device's remote control application changes to a particular state, the application of another handheld device's remote control application may remain in a state is less relevant to a current situation.

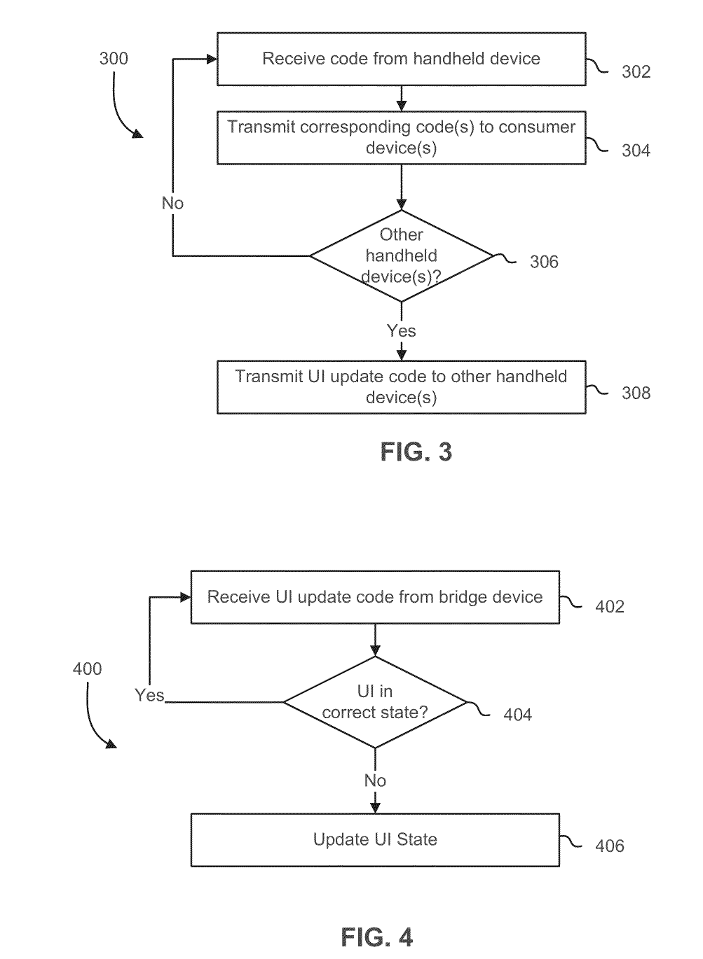

FIG. 3, accordingly, shows an illustrative example of a process 300 that may be used to manage some of the complexities introduced by use of multiple handheld devices as remote control devices. Some or all of the process 300 (or any other processes described herein, or variations and/or combinations thereof) may be performed under the control of one or more computer systems configured with executable instructions and may be implemented as code (e.g., executable instructions, one or more computer programs, or one or more applications) executing collectively on one or more processors, by hardware, or combinations thereof. One of more of the actions depicted in FIG. 4 may be performed by a device such as the bridge device illustrated in FIG. 2 or by multiple devices working in concert. The code may be stored on a computer-readable storage medium, for example, in the form of a computer program comprising a plurality of instructions executable by one or more processors. The computer-readable storage medium may be non-transitory.

In an embodiment, the process 300 includes receiving 302 a code from a handheld device. The code may have been encoded by one or more signals transmitted by the handheld device, such as described above. Once the code is received 302, in an embodiment, one or more corresponding codes are transmitted to one or more consumer devices, such as in a manner described above. A determination may be made 306 whether there are additional handheld devices. The determination may be made in various ways. For example, a device participating in performance of the method 300 may keep track of network connections between the device and handheld devices. If there are more than one open network connections, the determination may be that there are additional handheld devices. As another example, the device participating in performance of the method 300 may keep track of IP addresses of handheld devices that have communicated with the device over a period of time (such as an hour, day, week, month, or other time period). If communications have originated from multiple IP addresses during the time period, the determination may be that there are other devices. Generally, any suitable method of making the determination may be utilized.

If it is determined that there are other handheld devices then, in an embodiment, a user interface (UI) update code is transmitted to the other devices. The UI update code, in an embodiment, is a code that, when received by an application of a handheld device, causes the UI of the handheld device to update accordingly, either immediately or at an appropriate time (such as when the handheld device exits an inactive state). The UI update code may be of any appropriate type, and in some embodiments may differ, e.g. in the programming language or protocol used, from that of the UI of the handheld device. For example, the UI update code may include at least HTML, XML, Javascript, AJAX, Java, C#, C++, Objective C, C, Visual Basic, ASP/ASPX, Java Server Pages (JSP), Java Server Faces (JSF), Ruby on Rails, Perl, PHP, and/or Common Gateway Interface (CGI) code. Transmitting the code may be performed in any suitable manner. For example, if an IP network is utilized, the code may be transmitted to appropriate IP addresses, such as all IP addresses that have communicated with the device participating in performance of the method 300, or all IP addresses that have communicated with the device participating in performance of the method 300 except the IP address from which the received 302 code originated. As another example, the UI update code may be broadcast using a transmission method that handheld devices are able to use. For example, the UI code may be broadcast using radio frequency (RF) methods if the handheld devices are configured to receive RF communications. Generally, the UI update code may be transmitted in any suitable manner. As illustrated, the process 300 may continue if another code is received from the handheld device.

As with any process described herein, variations are considered as being within the scope of the present disclosure. For example, a determination whether there are other handheld devices may not be made, but the process 300 may include simply transmitting the UI update code each time a code is received from a handheld device. As another example, transmitting the corresponding code(s) and transmitting the UI update code(s) may be performed in a different order than illustrated or concurrently. Other variations are also considered as being within the scope of the present disclosure.

FIG. 4 shows an illustrative example of a process 400 that may be performed by one or more handheld devices, such as when the process 300 has been performed by another device or collectively by multiple devices. In an embodiment, the process 400 includes receiving 402 one or more UI update codes from a bridge device. In some embodiments, multiple handheld devices receive the UI update code, and in some of such embodiments, some or all of the handheld devices may differ in one or more ways, as discussed at least in connection with FIG. 2. In such embodiments where some of the handheld devices differ from that of others, the UI code transmitted to at least some of the handheld devices may differ in a fashion sensitive to the differing characteristics of each handheld device. For example, some of the handheld devices may be dedicated remote control devices, while others may include smartphones, tablet computing devices, and/or the like. As the nature of user interaction with such disparate handheld device types may differ (e.g., differing UIs), it is contemplated that, in some embodiments, the UI update code may also differ. The UI code may have been transmitted in any suitable manner, such as those described explicitly above. In some embodiments, the UI update codes are received by a device other than the handheld devices to which they are destined, such as a personal computer, server, audiovisual receiver, network device, media device, and/or other devices capable of communicating with the handheld device. In some embodiments, the receiving device relays, in either an unaltered or altered form, the UI code to the handheld devices. In some embodiments, the receiving device may use the UI code to influence its own operation, such as by displaying or changing a UI state of its own. As previously described, in some embodiments, the UI is transferred, directly or through an intermediary device, in any suitable manner, including, but not limited to, over a public communications network such as the Internet, over a local network (e.g., using WiFi, Bluetooth, IRDA, RF, or a wired local area network via, e.g., TCP/IP), over a mobile communications network such as GSM, UMTS, HSDPA, LTE and/or the like, via a proprietary data connection, or by any number of other methods for data connection. In embodiments where the UI code(s) are transmitted to multiple handheld devices, the transmission may be synchronous (i.e., simultaneously pushed to connected handheld devices), asynchronous individually transmitted on a per-device basis), or some combination, for example, synchronously to all currently connected handheld devices, and asynchronously to those known to the system but not currently connected. In some embodiments, the UI update code may be received in response to, e.g., a state change or signal, received by the bridge device, from a handheld device that does not require a specific UI update, such as a remote control specific to one of the controlled devices, and/or a multi-device or universal remote control without the ability to track device states. In such embodiments, the UI update code received may be generated, e.g., by the bridge device or another device or devices, to place other handheld devices in a UI state that reflects the change initiated, at least in part, by the triggering remote control. In an embodiment, when the UI update code is received, a determination is made 404 whether the UI is in a correct state. The UI update code may, for example, indicate the correct state that the UI should be in. The indication may be explicit or implicit. For example, each UI state may correspond to an identifier of the state. It is contemplated that in embodiments where multiple handheld devices are receiving the UI update code, the determination may, in some of such embodiments, be on a per-device basis. The indication may allow the handheld device to determine the identifier of the state and update 406 the state of the UI accordingly. As an example of an implicit indication, certain commands may only be available in certain states. The indication may indicate the command which would allow determination of the proper state, or at least one of a number of states that would be suitable. Generally, the determination may be made 404 in any suitable manner.

As illustrated, if it is determined that the UI is in the correct state, the UI state is updated 406 accordingly. If however, it is determined that the UI is not in the correct state, the process 400 may repeat if another UI update code is received 402 from the bridge device.

In some instances, a user may be presented with a UI screen that does not correspond to a proper state. For example, if the processes 300 and/or 400 are performed and one of the processes is not completed successfully, a handheld device may be left with a UI in an improper state. As another example, a handheld device may be out of communication, in an inactive state, a remote control application may not have been launched yet, and/or the handheld device may have otherwise been unable to realize any effect from performance of the process 300. As such, a user may attempt to interact with the remote control application of the handheld device from a screen that is inapplicable to a current activity being performed. As one example, a remote control application of a handheld device may have been used to put a set of consumer devices in a particular state, such as for watching television. A remote control application of another device may be in a state for watching a DVD, which may include controls for controlling a DVD player. As controls of a DVD player may not be relevant to watching television, the UI screen of the remote control application of the other device may not be relevant to the current activity (watching television). One way of putting the UI screen in the correct state is for the user to navigate to the correct screen. Navigation, however, may require the user to perform multiple steps, which may be time consuming, depending on the configuration of the UI.

FIG. 5 shows an illustrative example of a process 500 that may be used to efficiently put a UI of a handheld device (or multiple handheld devices) into a relevant state, in accordance with an embodiment. The process 500 may be performed by a bridge device, such as described above, and/or a combination of devices that work in concert. In an embodiment, the process 500 includes receiving 502 a code from a handheld device. The code may be received, for instance, upon user interaction with a remote control interface. In an embodiment, when the code is received 502, a determination is made whether the received code corresponds to a current state, such as a current activity state in which one more devices are collectively in. The determination may be made in any suitable manner. For example, each of a plurality of possible states may correspond to a set of commands. The determination may be made, in an embodiment, by checking whether a command corresponding to the received code is in a set corresponding to the current state. It should be noted that some commands may correspond to multiple or even all states. For example, if the code corresponds to “power all devices off,” such a command may be applicable to any state (except, in some embodiments, astute corresponding to all devices being in a powered off state). For such commands, in an embodiment, when a corresponding code is received, the determination will always be positive. In this manner, users may, for instance, power off all devices regardless of what state the devices are in.

In an embodiment, if it is determined 504 that the code does not correspond to a current state, a UI update signal is transmitted 506 to the handheld device that sent the code (and possibly one or more other handheld devices). The UI update signal may indicate to the handheld device to update its UI, such as in a manner described above. If it is determined that the received code does correspond to a current state, one or more corresponding code(s) may be transmitted 508 to one or more appropriate devices, such as in a manner described above.

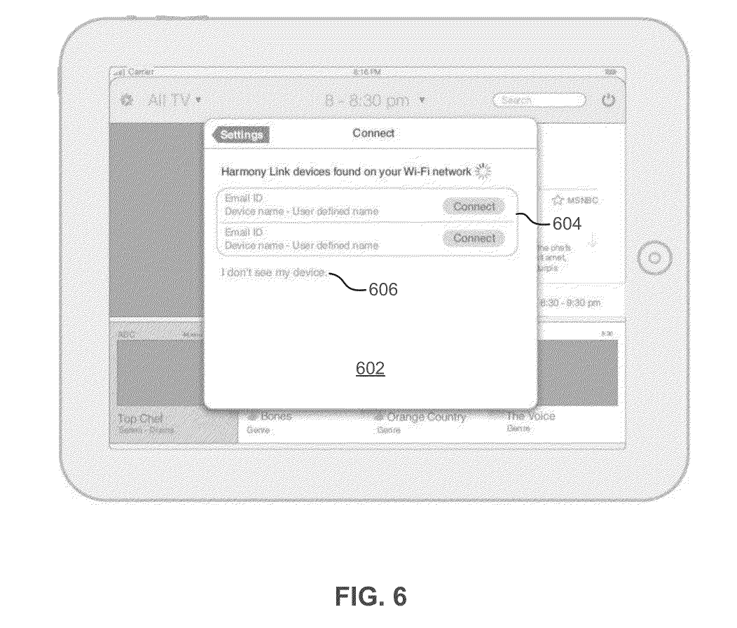

FIGS. 6 through 11 provide illustrative examples of interface screens and some explanatory comments in accordance with the example embodiment illustrated. The interface screens illustrated in FIGS. 6 through 11 may be part of an application executing on a handheld device or on multiple handheld devices). The example interface provides an intuitive and easy to use interface for users that use such a handheld device for controlling one or more devices. The user interface may be presented on a touch screen of a handheld device, such as a tablet computing device and/or a mobile telephone and/or personal music player and/or other suitable device with a touch screen, The user may interact with the user interface by touching appropriate locations on the touch screen and moving appendages in contact with the touch screen accordingly.

Various features of the illustrated interface are provided in a manner that enhances the user experience. For example, FIG. 6 shows an interface 602 for connecting one or more handheld devices to a bridge device over a network. The interface shows one or more available bridge devices 604, e.g., as detected over a Wi-Fi network, to which the handheld device displaying the interface may be connected. Upon providing a selection, the user may be required to supply any authentication necessary to connect with the selected bridge device, such as a password. The user is also provided an option for specifying additional information 606 identifying a desired bridge device if the desired bridge device is not shown.

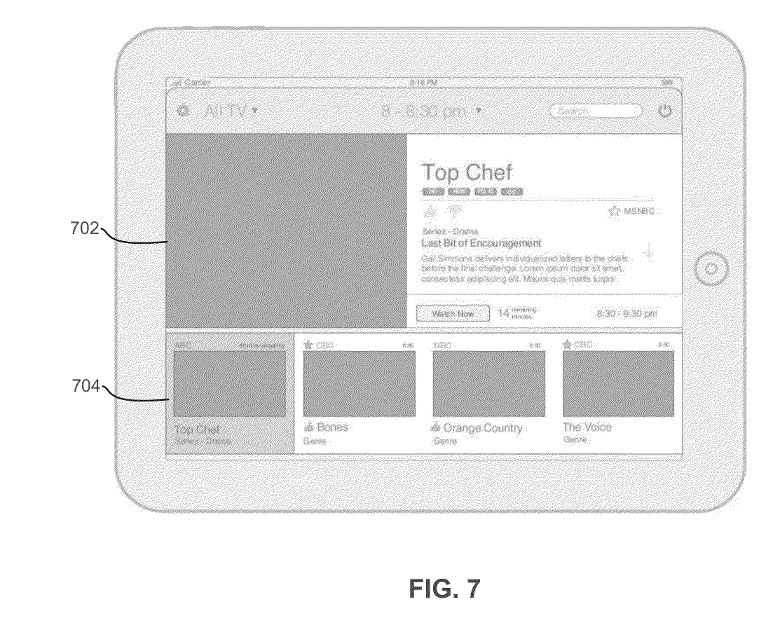

FIG. 7 shows a content-driven presentation 702 for allowing users to select content based on the content itself and not in less intuitive ways, such as by scrolling through a program guide that shows content available according to channels and other non-intuitive indices. Selectable options for content 704 may be provided and ordered based at least in part on user behavior. For example, shows that a user may select to watch may be presented in an ordering based on recorded user behavior. Shows that a user watches often, for example, may be displayed more prominently than other shows. When a user selects a show, the handheld device may transmit a signal that causes a channel change in another device that corresponds to the selected show, such as in a manner described above. In an embodiment, when a user selects an option, an entire relevant activity may be launched according to the selection. For example, if a user selects a show, a Watch TV activity may be launched with a set top box or television tuner tuned to a channel appropriate for viewing the show, such as a channel currently showing or about to present the selected show. If the show is available through various activities (such as through streaming or through a television broadcast), an appropriate activity may first be selected. For example, if the selected show is not currently being or about to be broadcast, an activity for streaming content from a remote server may be launched. Launching the activity may include, placing a device in a mode for accessing remotely streamed content, authenticating the user for access of the remotely streamed content, launching a third-party application for streaming content (which may include interacting with an API of the third party application), and/or other actions for viewing streamed content. In this manner, the user is able to select content for viewing without having to search through multiple possible sources. Generally, embodiments of the present disclosure allow users to select content that they desire without having to worry about its source.

Other user interface elements may also be provided based at least in part on recorded user behavior. For example, a user may select to have displayed favorite shows, shows in general, movies, sports, or news. These choices may be ordered based at least in part on recorded user behavior such that choices that a user is most likely to select are provided first, Upon selection of a category of content, specific examples of the content of the category may be presented. For example, if the user selects “favorite shows,” shows that the user has indicated has his favorites (either explicitly or implicitly through behavior) and that are available for viewing may be presented.

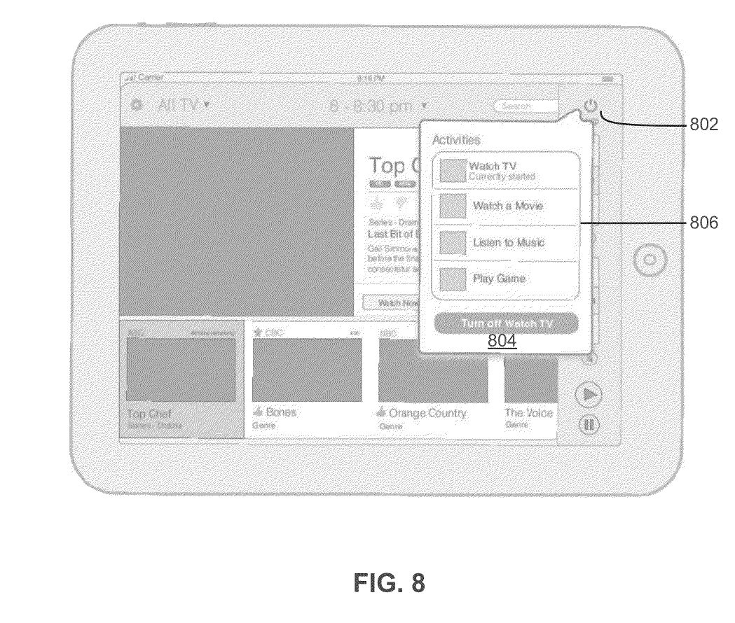

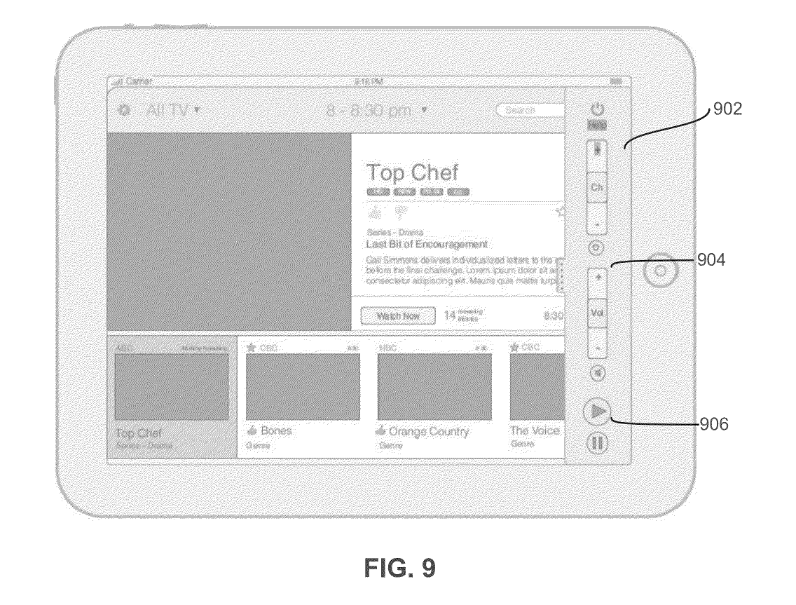

As noted above, users have the ability to select various activities and selection of an activity will cause the handheld device to transmit one or more signals that cause one or more appropriate devices to be in a correct state for participating in the activity. For example, as illustrated in FIG. 8, an icon 802 in the upper right corner of the screen is selectable to cause an activity pop-up box 804 to overlay on the display. The pop-up box includes various activities that the user may select 806. FIG. 9 shows an illustrative example of how the interface may look upon selection of, e.g., a Watch TV activity. In particular, a slide panel 902 may be shown on the right hand side of the interface. The slide panel includes controls for controlling aspects of watching television 904, such as what channel is shown and the volume of the sound. Controls for a digital video recorder (DVR) may also be present 906.

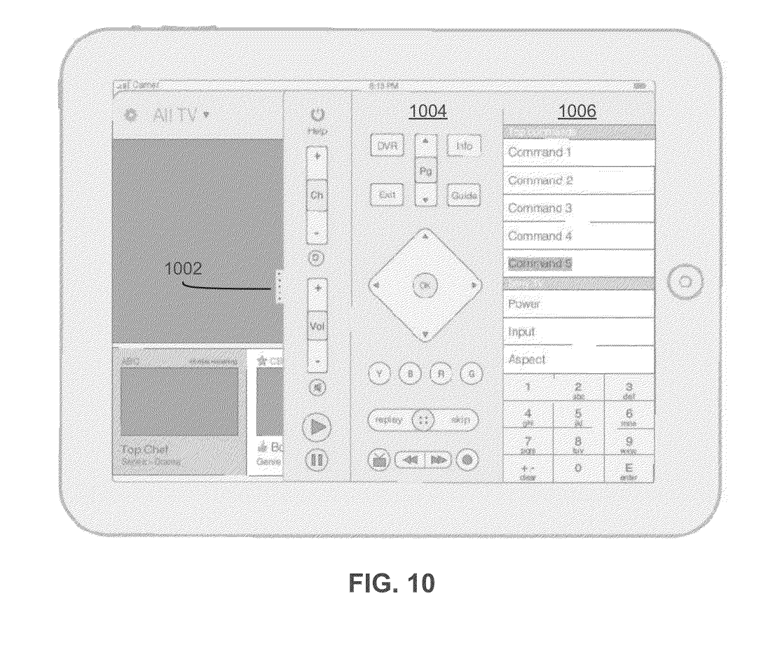

As shown in FIG. 10, the slide panel of, e.g., FIG. 9 may include a pull tab (thumb) 1002. The user, in this example, may touch the screen at the location of the pull tab and drag the pull tab (for instance by moving a finger to the left while remaining in contact with the touch screen) to the left to introduce another slide panel with more options 1004, such as more advanced and/or less frequently used commands relevant to the selected activity. In the illustrated example, advanced DVR and TV controls are shown. The pull tab may be pulled to the left even further to introduce yet another panel with more options 1006, which may be yet more advanced or seldom-used, or, in some embodiments, less relevant to the given activity.

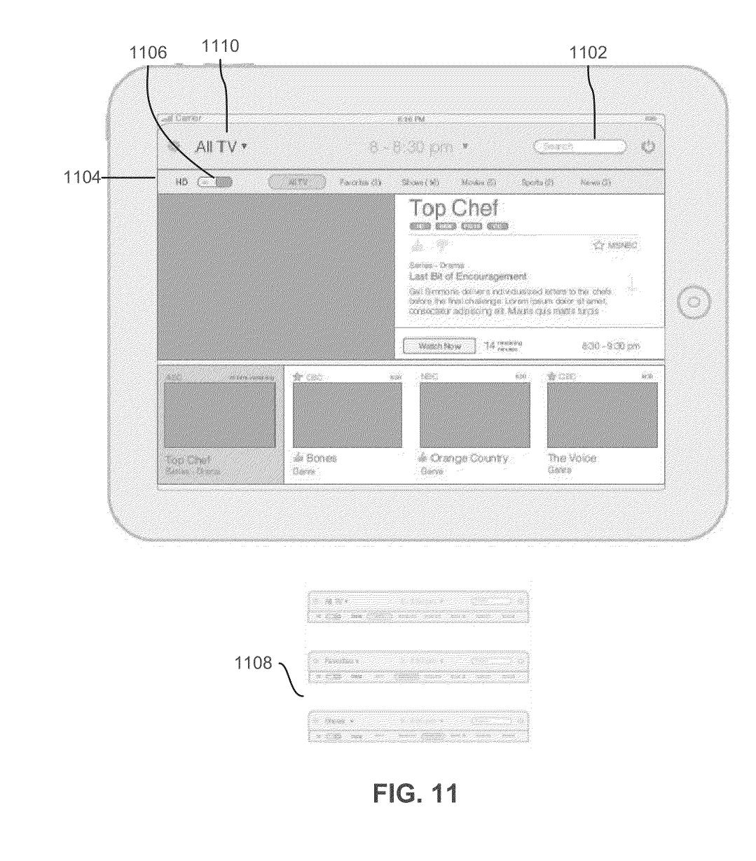

As shown in FIG. 11, a search bar 1102, e.g., in the upper right hand corner of the screen, allows a user to search for commands of one or more devices. In this manner, the user does not need to look through multiple buttons and menus for the right command, but can find the right command through searching. Executing a search may filter commands already shown 1104. The commands may be ordered in a useful way. For example, the commands may be ordered based at least in part on a determination of a most likely needed command. For example, due to some content available in high definition (HD) and other content available in standard definition (SD), television aspect ratios often need to be adjusted. Therefore, a command relating to changing a television aspect ratio may appear prominently 1106. As a filtered command is selected, the displayed context may change 1108, e.g., by changing a title in the toolbar 1110. Commands that are readily available on the other slide panels may be excluded, in some embodiments. In this manner, if a user wants to make a particular adjustment to a device state, perhaps because he or she sees a problem and knows the solution, he or she can easily navigate to the correct command without having to navigate through multiple menus.

In addition, the commands shown may be for multiple devices, The shown devices may be those devices participating in a current activity. Other devices not currently participating may also be shown, but less prominently, For example, commands for devices currently not participating in a current activity may be found by scrolling down a list of commands to a portion of the list of commands that is not currently shown in the interface screen.

The description given above and elsewhere in this present disclosure is merely illustrative and is not meant to be an exhaustive list of all possible embodiments, applications or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments.

As discussed above in, aspects of the present disclosure may be performed in various ways, some of which are described above. Some ways of practicing various aspects of the present disclosure are described in, but not limited to, techniques described in U.S. application Ser. No. 17/993,248 (noted above and incorporated herein by reference) describes various ways of receiving information in one format and re-transmitting corresponding information in another format. The techniques in U.S. application Ser. No. 12/993,248, and variations and adaptations thereof, may be used, for example, to enable use of a handheld device to control one or more consumer devices by causing the handheld device to transmit information to a bridge device, as described above. Some ways of maintaining state information may are described in U.S. application Ser. No. 09/804,718 (noted above and incorporated herein by reference). The techniques of U.S. application Ser. No. 09/804,718, and variations and adaptations thereof, may be used in various embodiments to maintain information regarding the state of one or more devices, such as the state of a UI on one or more handheld devices and the state of one or more consumer devices being controlled using one or more handheld devices.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to ⁻the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A remote control system, comprising:
one or more processors; and
memory including instructions executable by the one or more processors to cause the remote control system to at least:
receive, from a first handheld device, one or more signals corresponding to a state of a set of one or more controllable appliances; and
causing transmission of, to a second handheld device having a remote control graphical user interface, one or more signals that collectively enable the second handheld device to update the remote control graphical user interface to correspond to the state.

2. The remote control system of claim 1, wherein the first handheld device is remote control device.

3. The remote control system of claim 1, wherein:
the first handheld device has a remote control graphical user interface;
the one or more signals corresponding to the state of the set of one or more controllable appliances is generated responsive to user input to the graphical user interface;
the memory includes instructions that, when executed by the one or more processors, cause the remote control system to further:
receive, from the second handheld device, one or more other signals corresponding another state of the set of one or more controllable appliances; and
cause transmission, to the first handheld device, of one or more other signals that collectively enable the first handheld device to update the remote control graphical user interface of the first handheld device to correspond to the other state.

4. The remote control system of claim 1, wherein:
at least one of the first handheld device or second handheld device is connected to the remote control system by a local communication network; and
transmission of the one or more signals that collectively enable the second handheld device to update the remote control graphical user interface occurs over the local communication network.

5. The remote control system of claim 4, wherein causing transmission of the one or more signals that collectively enable the second handheld device to update the remote control graphical user interface includes:
causing another device to transmit the one or more signals that collectively enable the second handheld device to update the remote control graphical user interface.

6. The remote control system of claim 1, wherein:
the memory includes instructions that, when executed by the one or more processors, cause the remote control system to further upon receipt of the one or more signals corresponding to the state of the set of one or more controllable appliances, determine, based at least in part on the state, whether to cause transmission of the one or more signals that collectively enable the second handheld device to update the remote control graphical user interface; and
as a result of determining to cause transmission of the one or more signals, causing transmission of the one or more signals that collectively enable the second handheld device to update the remote control graphical user interface.

7. The remote control system of claim 1, wherein the first handheld device and the second handheld device are different types of devices.

8. The remote control system of claim wherein:
the one or more signals corresponding to the state of the set of one or more controllable appliances are in accordance with a first communication protocol; and
the one or more signals that collectively enable the second handheld device to update the remote control graphical user interface are in accordance with a second communication protocol that is different from the first communication protocol.

9. The remote control system of claim 1, wherein:
prior to receipt of the one or more signals corresponding to the state of the set of one or more controllable appliances, the set of one or more controllable appliances is in a first state corresponding to consumption of media in a first mode; and
the state corresponding to the one or more signals corresponds to consumption of media in a second mode different from the first mode.

10. The remote control system of claim 1, wherein the memory includes instructions that, when executed by the one or more processors, cause the remote control system to further transmit one or more command signals to at least a subset of the set of one or more controllable appliances to put the set of one or more controllable appliances in the state.

11. A computer-implemented method of updating graphical user interface state among a set of handheld devices, comprising:
receiving, from a first handheld device of the set of handheld devices, one or more signals for causing a state of a set of one or more controllable appliances to change to a new state;
taking one or more actions that cause one or more other handheld devices to synchronize corresponding remote control graphical user interfaces according to the new state.

12. The computer-implemented method of claim 10, wherein the first handheld device is a remote controller.

13. The computer-implemented method of claim 11, wherein:
the first handheld device has a first remote control graphical user interface; and
the method further comprises taking one or more other actions that cause the first remote control graphical user interface to update as a result of a second handheld device of the set of one or more handheld devices causing another change in state of the set of one or more controllable appliances.

14. The computer-implemented method of claim 11, wherein:
at least one second handheld device of the one or more other handheld devices is connected to the remote control system by a local communication network; and
the one or more actions include transmission of a signal over the local communication network to the second handheld device.

15. The computer-implemented method of claim 11, wherein taking one or more actions that cause the one or more other handheld devices to synchronize corresponding remote control graphical user interfaces is performed as a result of a determination to take the one or more actions.

16. The computer-implemented method of claim 11, wherein:
the one or more signals are according to a first communication protocol; and
the one or more actions include causing transmission of a signal of a second communication protocol different from the first communication protocol.

17. The computer-implemented method of claim 11, wherein changing to a new state includes causing at least one controllable appliances of the set of controllable appliances to change a mode of consuming media content.

18. The computer-implemented method of claim 11, further comprising transmitting one or more signals to at least a subset of the set of one or more controllable appliances to cause the set of one or more controllable appliances to be in the new state.

19. A non-transitory computer-readable storage medium having stored thereon instructions that, when executed by one or more processors of a handheld device, cause the handheld device to:
receive, from a first device, at least one signal corresponding to a change of state of a set of one or more controllable appliances to a new state, the change of state initiated by another handheld device; and
update a remote control graphical user interface of the handheld device to enable the graphical user interface to be usable to control at least a subset of the set of one or more controllable appliances according to the new state.

20. The computer-readable storage medium of claim 19, wherein the instructions further include instructions that, when executed by the one or more processors, further cause the handheld device to:
accept, by the graphical user interface, user input for controlling at least one of the one or more controllable appliances; and
take one or more actions that cause the at least one of the one or more controllable appliances to function in accordance with the accepted user input.

21. The computer-readable storage medium of claim 20, wherein the one or more actions include transmitting, to the first device, a signal corresponding to the accepted user input.

22. The computer-readable storage medium of claim 19, wherein the instructions further include instructions that, when executed by the one or more processors, further cause the handheld device to poll the first device to cause the first device to transmit the at least one signal.

23. The computer-readable storage medium of claim 19, wherein receiving the at least one signal is performed without transmission of the at least one signal from the first device having been initiated by the handheld device.

24. The computer-readable storage medium of claim 19, wherein:
prior to receipt of the signal, the set of one or more controllable appliances is in a previous state;
when the set of one or more controllable appliances is in the previous state, the graphical user interface has a set of one or more selectable remote control functions; and
updating the remote control graphical user interface includes changing the set of one or more selectable remote control functions.

25. The computer-readable storage medium of claim 19, wherein receiving the at least one signal is performed over a local communication network.

26. The computer-readable storage medium of claim 19, wherein:
receiving the at least one signal is performed according to a first communication protocol; and
wherein the state of the set of the one or more controllable appliances is changeable using at least one other communication protocol different from the first communication protocol.
